(19) United States
(12) Patent Application Publication
(10) Pub. No.: US 2007/0186351 A1
(43) Pub. Date: Aug. 16, 2007

(54) MULTI FUNCTION TOOL

(75) Inventors: Eric Linn, Post Falls, ID (US); Mark McLean, Spokane, WA (US); Michael Dolmage, Spokane, WA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Buck Knives, Inc., Post Falls, ID (US)

(21) Appl. No.: 11/669,073

(22) Filed: Jan. 30, 2007

Related U.S. Application Data
(60) Provisional application No. 60/771,964, filed on Feb. 9, 2006.
(60) Provisional application No. 60/763,622, filed on Jan. 30, 2006.

(51) Int. Cl. B25B 7/22; B26B 11/00; B25F 1/00; B25B 13/10

(52) U.S. Cl. 7/129; 7/142; 7/158

(57) ABSTRACT

The present disclosure relates to multi-function tools, and particularly to a mechanism for extending and retracting pliers and the like into the handle. Along with the pliers the multi-tool may have various other implements including a full-size blade, a driver tool, a can opener, a punch tool and the like. Furthermore a lighting element, being either an LED or non-LED type mechanism, and either fixed in place or rotatable or flexible about the handle is comtemplated.

### CROSS-REFERENCES TO RELATED APPLICATIONS

This application claims benefit of priority from U.S. Provisional Patent Applications 60/763,622, filed Jan. 30, 2006 and 60/771,964, filed Feb. 9, 2006 both of which are hereby incorporated in their entirety as if fully set forth.

### BACKGROUND OF THE INVENTION

Multi-function tools are well known. In a typical multi-tool, the main tool is the pliers. The pliers shape is adapted to allow other tools to be placed within the handles. This makes the overall tool awkward and bulky. To use such a tool, the pliers must first be opened, another tool folded out, and the pliers closed. This creates a lot of extra steps to use one of the other tools.

### BRIEF SUMMARY OF THE INVENTION

In the present invention the multi-tool has the form of a common folding knife. The tool has a full size blade and may include retractable pliers, needle-nose pliers, scissors, screwdrivers, shears, wire cutters, tin snips and the like. One embodiment of the present invention includes a tool with a full size blade and pliers. The tools all slide or rotate out of the handle. Another embodiment is the way the retractable tool such as the pliers slide and move from the retracted, put away, position within the handle of the tool, to a locked functioning position wherein the plier tool is locked in place and capable of performing the tasks typically associated with a single plier tool. This allows one-handed access to all the tools in one step.

The present invention is a folding knife tool that includes a handle with opposing sides, wherein the opposing sides define an opening for housing a blade when the blade is in a folded position. The opening further defines a housing for a two-piece tool implement to extend from or retract into, and a locking mechanism is provided to lock the two-piece tool implement into the extended or open usable position. The two-piece tool implement may be, but is not limited to, pliers, needle-nose pliers, scissors, shears, wire cutters, tin snips, gardening clippers, and the like. Also the handle may further include multiple other tool implements.

The present invention also includes a folding knife tool with a sliding double ended driver that locks into an extended position. The housing may include other tools that may slide or fold out.

### BRIEF DESCRIPTION OF THE DRAWINGS

FIG. 1 is an exploded view of the folding knife tool.

FIG. 2 is a rear view of the folding knife tool with the pliers in the retracted position.

FIG. 3 is a rear view of the folding knife tool with the pliers sliding toward the extended position.

FIG. 4 is a rear view of the folding knife tool with the pliers sliding toward the extended position and starting to engage the locking arm.

FIG. 5 is a rear view of the folding knife tool with the pliers sliding toward the extended position and the locking arm being retracted by the pin on the pliers.

FIG. 6 is a rear view of the folding knife tool with the pliers in the extended position and the locking arm engaging the pin on the pliers.

FIG. 7A is a left end view showing the location of the driver within the liners within the handles.

FIG. 7B is a front view of the folding knife tool with the driver in the center position and the locking button pin engaging the extension in the slot or extending into the slot.

FIG. 8 is a front view of the folding knife tool with the driver in the center position and the locking button pushed down disengaging the pin from the extension in the slot.

FIG. 9 is a front view of the folding knife tool with the driver sliding toward the front thereby extending the phillips end of the driver.

FIG. 10 is a front view of the folding knife tool with the driver phillips end extended in the open position and the locking button pin in the extension of the slot, locking the driver in place.

FIG. 11 Top left is a top view of the multi-function tool. Middle left is a side view with the right side handle cut away to view the illuminating element and the driver and bit storage. Bottom left is a side view with the right side handle cut away and the driver rotated in the open position. Top right is an angled side view with the right side handle cut away to view the 3D components of the illuminating element and the driver and bit components. Bottom right is a side and end view of a standard bit.

FIG. 12 Top left is a top view of a multi-function tool. Bottom left is a side view of a multi-function tool. Top right is a top angled side view of a multi-function tool. Bottom right is a bottom angled side view of a multi-function tool.

FIG. 13 Left side is a side view with the right side handle cut away to show the illuminating element and driver implement. Right side is an angled side view with the right side handle cut away to show the features of the illuminating element.

FIG. 14 Top left is a top view of the multi-function tool. Middle left is a side view with the right side handle cut away to view the illuminating element and the driver and bit storage. Bottom left is a side view with the right side handle cut away and the driver rotated in the open position. Top right is an angled side view with the right side handle cut away to view the 3D components of the illuminating element and the driver and bit components. Bottom right is a side and end view of a standard bit.

FIG. 15 Top left is a top view of a multi-function tool. Bottom left is a side view of a multi-function tool. Top right is a top angled side view of a multi-function tool. Bottom right is a bottom angled side view of a multi-function tool.

FIG. 16 Left side is a side view with the right side handle cut away to show the illuminating element and driver implement. Right side is an angled side view with the right side handle cut away to show the features of the illuminating element.

FIG. 17 Top left is a top view of the drive tool implement slidably held in its open position with an adapter tool placed on the drive tool implement. Bottom left is a side view of the drive tool implement slidably held in its open position with an adapter tool placed on the drive tool implement. Top right are angled side and end views of the adapter tool. Bottom right are angled side and end views of the end bit.

FIG. 18 Top left is a top view of the multi-function tool with the drive tool implement slidably held in the retracted position. Bottom left is a side view of the multi-function tool with the drive tool implement slidably held in the retracted position. Top and bottom right are angled side views of the drive tool implement slidably held in the open position with an adapter tool placed on the drive tool implement.

FIG. 19 Left side is a side view with the right side handle cut away to show the illuminating element and driver implement. Right side is an angled side view with the right side handle cut away to show the features of the illuminating element.

### DETAILED DESCRIPTION OF THE INVENTION

By folding blade implement is meant a blade pivotally connected to the handle which when pivoted into the open position may or may not be locked in the open position with either a liner lock or other well known blade locking mechanisms. The blade may have a single- or double-sided cutting edge and may or may not include other common blade features, such as being serrated or having a hook.

By two-piece tool implement is meant a tool that generally requires dual handles for best functioning such as scissors, pliers, needle-nose pliers, wire cutters, tin snips, gardening shears and clippers, pipe cutters, and the like. The two-piece tool implement may be slidably held within the handle of the multi-function tool and optionally locked into position when in the user mode and retracted within the handle and optionally locked when in the stored mode.

By drive tool implement is meant any tool that performs a driving type function e.g., screwdriver, such as a cordless screwdriver or hand driver, including but not limited to, drill bits, allen wrench adapters, standard and philips head screw adapters, hexagonal, octagonal, or other geometric head adapters or drivers, or punch tools. The drive tool implement may be pivotally attached to said handle or slidably held within said handle. When slidably held, the drive tool implement may have a different driver bit on either end of said drive tool implement, e.g., a phillips head screwdriver on the right side and a standard slot screwdriver on the left side. The drive tool implement optionally may be locked in the user mode whether it is pivotally attached or slidably held. The drive tool implement may further fit within an adapter, which incorporates a variety of driver-bit heads for use with the present invention.

By illuminating element is meant an element capable of illuminating or lighting an area or a work surface which is either fixed on or within the handle, or flexibly or pivotally attached so that the illuminating element may be directed at various work surfaces in relation to the handle of the multi-function tool. The illuminating element may be an LED type illuminating element and it may further be powered by an exhaustible or inexhaustible power source. The illuminating element also may have a microchip responsible for controlling certain illumination features such as an automatic shut-off, various degrees of illumination intensity, and/or blinking or flashing functions.

An embodiment of the present device comprises a multi-function tool comprising: a handle; a folding blade implement; and a two-piece tool implement; wherein said folding blade implement is pivotally connected to the handle of said multi-function tool, and folded within the handle when in a stored state, and pivotally rotated out of the handle when in use; and wherein said two-piece tool implement is slidably held so that said two-piece tool implement is retracted within the handle when in the stored state, and slidably extended to protrude from said handle when in use.

Another embodiment of the present device comprises a multi-function tool comprising: a handle; a folding blade implement; a two-piece tool implement; and a drive tool implement; wherein said folding blade implement is pivotally connected to the handle of said multi-function tool, and folded within the handle when in a stored state, and pivotally rotated out of the handle when in use; wherein said two-piece tool implement is slidably held so that said two-piece tool implement is retracted within the handle when in the stored state, and slidably extended to protrude from said handle when in use; wherein said drive tool implement is slidably held so that said drive tool implement is retracted within the handle when in the stored state, and slidably extended to protrude from said handle when in use.

As described above the embodiment may feature a variety of folding blade implements whether a single or double sided cutting blade or comprising a serrated or saw type portion. The blade implement may also have a blade locking feature which may utilize a liner lock type mechanism or any other common blade locking mechanism known to those skilled in the art to lock the blade in an open position. The blade may also contain a thumb stud attachment which assists with blade opening and may serve as a stop against the handle of the multi-function tool when the blade is in a fully open position, and thus prevent hyperextension of the blade beyond the 180 degree open position.

Another embodiment of the present invention is a multi-function tool comprising a handle; a folding blade implement; a two-piece tool implement; and a drive tool implement as described above, and further including an illuminating element. The illuminating element may be fixed on the handle, or pivotally or flexibly attached to the handle. The purpose of the illuminating element is to illuminate the work area directly around the given blade or tool implement in use. The illuminating element is strategically placed so that most or all work areas surrounding each blade or tool implement are illuminated. If each of the implements function in the same direction as a fixed illuminating element, they will be illuminated. Alternatively, the illuminating element is flexibly or pivotally attached to said handle and thereby can illuminate either or both ends of the handle. Another option is for an illuminating element to be located at both ends of the handle.

The illumination element may be an LED, which may further include a switch power source microchip and other features well known in the art.

Another embodiment of the present invention comprises a multi-function tool comprising; a handle; a folding blade implement; a two-piece tool implement; a drive tool implement and an illuminating implement. The folding blade implement is pivotally connected to the handle of the multi-function tool so that the blade may be folded into at least a portion of the handle when stored in the closed position, and pivotally rotated out of the handle when in an open position. Upon reaching the fully open position, the blade may further lock into a fixed position utilizing most preferably a liner lock mechanism. The multi-function tool of the present embodiment also includes a two-piece tool implement which is slidably held so that the two-piece tool implement is retracted within the handle when in the stored state, and slidably extended to protrude from the handle when in use. Further, the drive tool implement may be pivotally connected to the handle so that the drive tool implement is folded within the handle when in a stored state and pivotally rotated out of the handle when in use. The present embodiment also has an illuminating element, as described above, fixed onto the handle of the multi-function tool.

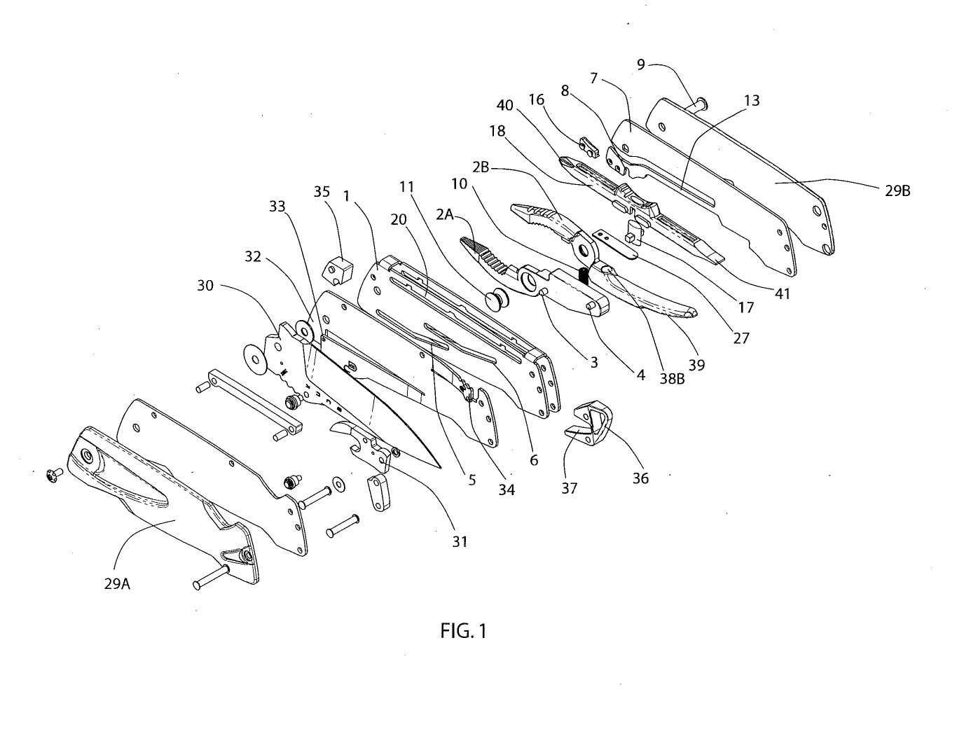

Another embodiment of the present invention is a folding knife tool shown in FIG. 1, comprising a handle and multiple liners within the handle; the liners have different functions. There are liners for stability, there are locking liners 7 and 32, and tracking liner 1. Tracking liner 1 further contains tracks 5 and 6 for sliding and retracting pliers; also tracking liner 1 contains slot 20 for sliding and retracting the double ended driver 18. The embodiment further comprises a blade pivotally connected to the handle and a means for retracting and extending pliers; wherein the pliers have a first exposed handle and a second unexposed handle slidably connected to the folding knife handle; and wherein the exposed pliers handle is extended or retracted within the folding knife handle. The pliers have two button pins fixed to the second unexposed handle wherein the pins 3 and 4 allow the pliers to slide within the two tracks 5 and 6 within the tracking liner 1. Each pin is associated with a track which maintains the pliers in a fixed orientation.

Another embodiment disclosed herein is a folding knife tool with retractable pliers and a driver, which lock into position. As shown in FIG. 1, a folding knife tool includes a handle or housing 29 with opposing sides 29A and 29B defining an opening to house the blade 30, the pliers 2, with pivot pin 11, the driver 18, and a can opener 31 when in a closed position. In the embodiment shown, the blade 30 may be rotated around pin 9 to the open position by a user and then locked in the open position by the locking liner 32 and lock arm 33. The can opener 31 may be rotated to the open position and locked by locking liner 32 and lock arm 34. Spacer 35 is located between tracking liner 1 and locking liner 32.

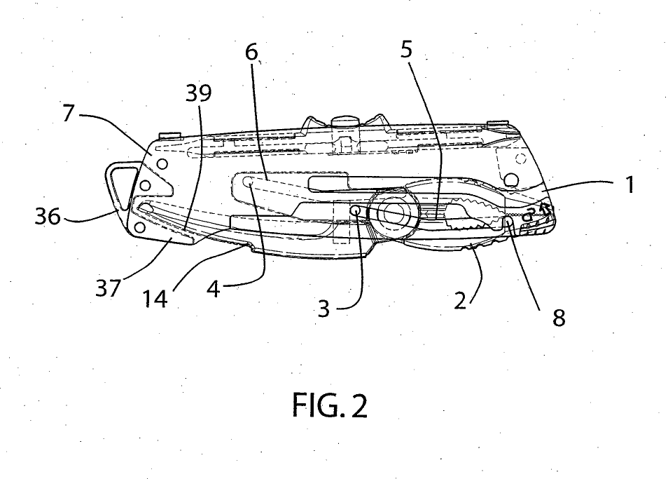

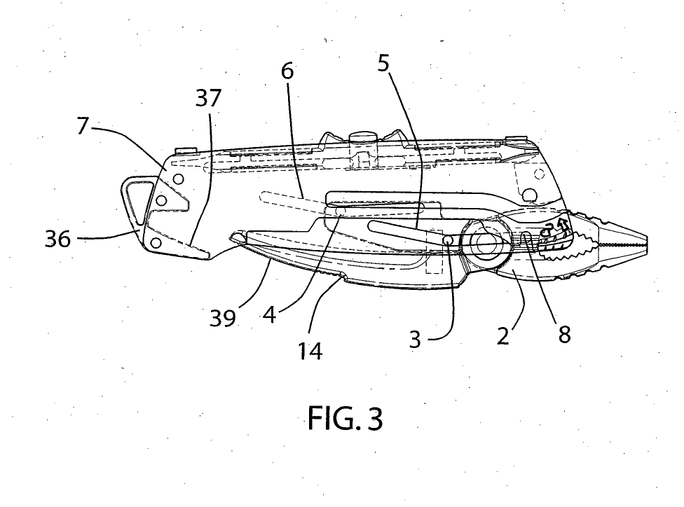

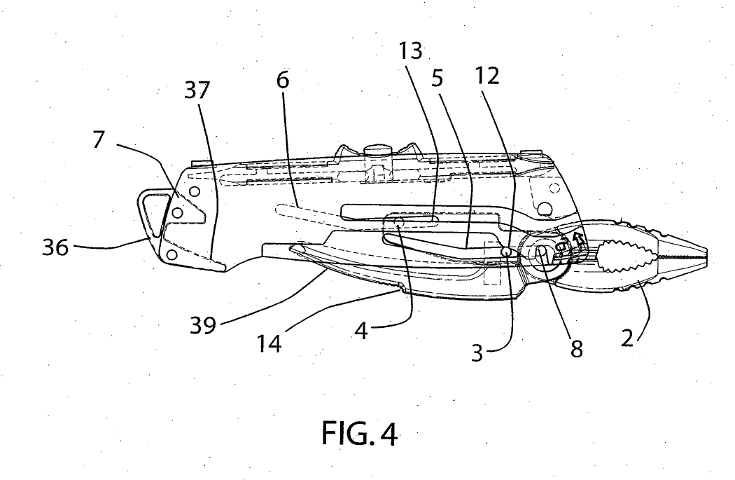

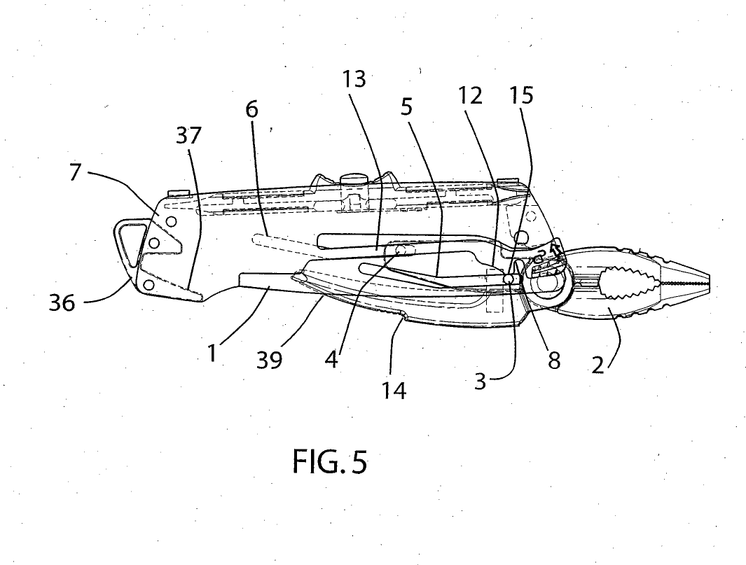

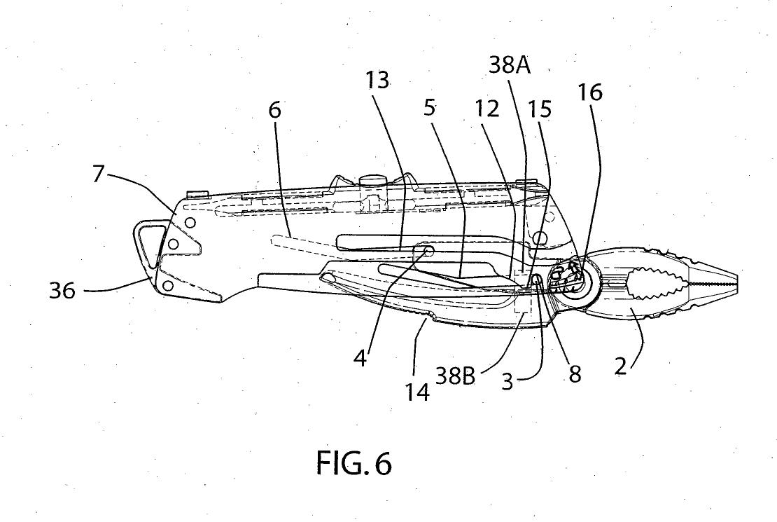

As shown in FIGS. 2-6, the pliers 2 can be extended or retracted into and out of the handle and locked in the extended or open position. When retracted as shown in FIG. 2, the pliers are held in position by friction between the pliers' handle 39 and the lanyard 36 via extension 37. As the user exerts a force on the pliers' handle thumb ridge 14 shown in FIG. 3 toward the forward direction, the pliers handle 39 slips away from the lanyard extension 37, while the pins 3 and 4 of the pliers follow the tracks 5 and 6 respectively. As shown in FIG. 4, the pliers are being guided through the pins in the tracks toward the extended position, with pin 3 in track 5 forcing the liner locking arm 13 upward as the pin 3 makes contact with the arm 13 at the concave arc 12. FIG. 5 shows the liner locking arm 13 at its highest position as pin 3 makes contact at edge 15 of the arm. FIG. 6 shows the pliers in the fully extended position and the liner locking arm 13 pushes down locking pin 3 into position within the convex arc 8. The pliers may be retracted in reverse order by the user applying an upwards force on the pliers' lock button 16 and then applying a backwards force on the pliers handle 39. When in the extended position, the pliers 2 can be spring loaded by spring 10, which is held within a slot 38A and 38B in the pliers handles 2A and 2B to open the pliers handle 39.

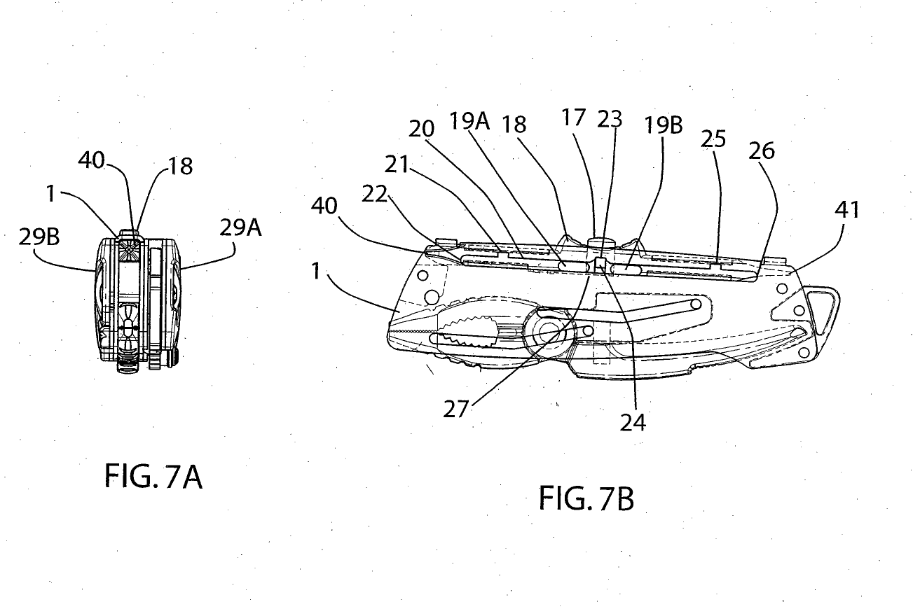

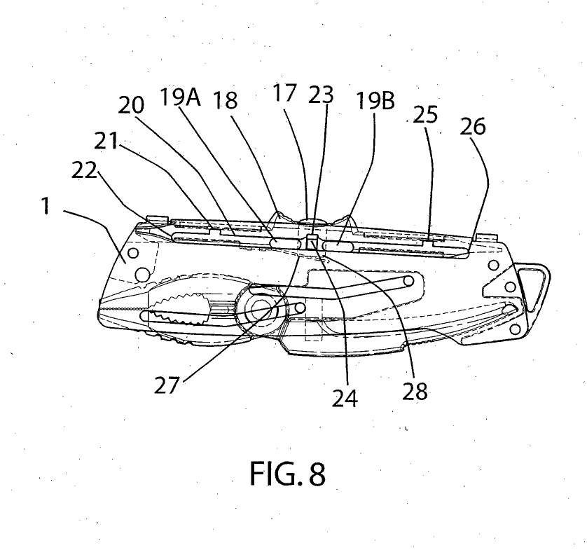

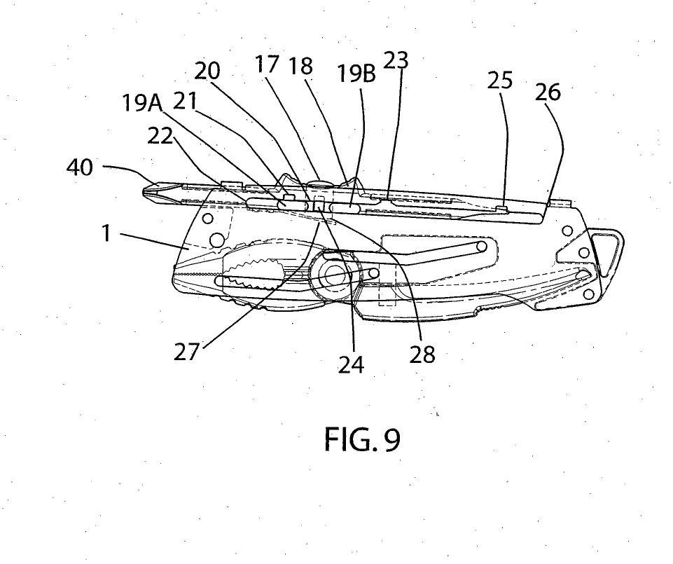

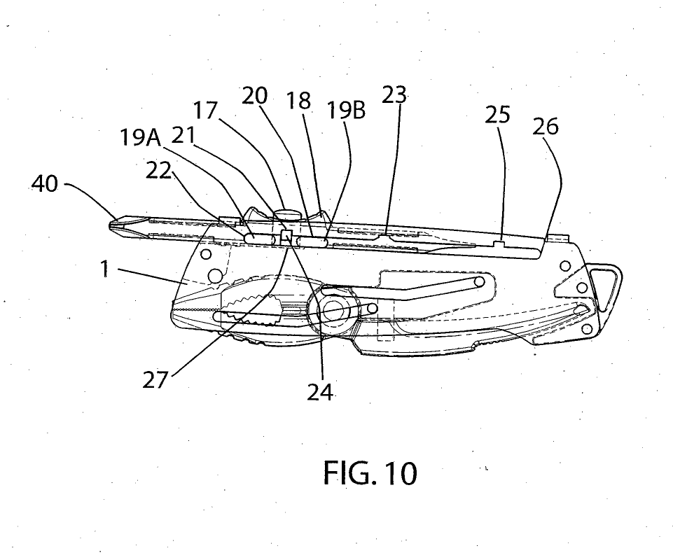

In the embodiment shown, the folding knife tool has a sliding driver 18. As shown in FIGS. 7-10 the driver can be extended in either direction and retracted to a center position and locked in place. FIG. 7B shows the driver 18 at the center position 23, thus both ends the phillips 40 and flathead 41 are housed within the handles 29A and B of FIG. 7A. The driver is locked into position when no external downward force is being applied to the button 17. The spring 27 forcing the pin 24 of the button up into slot extension 23 prevents any sliding movement of the driver by way of the driver pins 19A and B within the slot 20 of tracking liner 1. When the user applies a downward force on the button 17 as shown in FIG. 8, the bottom of the button 28 pushes down on the spring 27 and the button pin 24 is disengaged from the center extension slot 23. This allows sliding movement of the driver 18. The user moves the driver sideways, which rides on the driver pins 19A and B within the slot 20. If the user moves the driver toward the phillips 40 end as shown in FIG. 9, once the pin 24 is past the center 23 position, the pin will be held within the slot 20. When the driver is fully extended to the phillips 40 side as shown in FIG. 10, the driver pin 19A will stop at the end of the track 22 and the button pin 24 will be allowed to move upward by the force from spring 27 and engage the slot extension 21. This will lock the driver in position.

To unlock the driver, the user presses down the button 17 and slides the driver 18 sideways toward the center position 23. Similarly when the driver is moved to the flat driver 41 side, the driver pin 19B will stop at the end of the track 26 and the button pin 24 will engage slot extension 25.

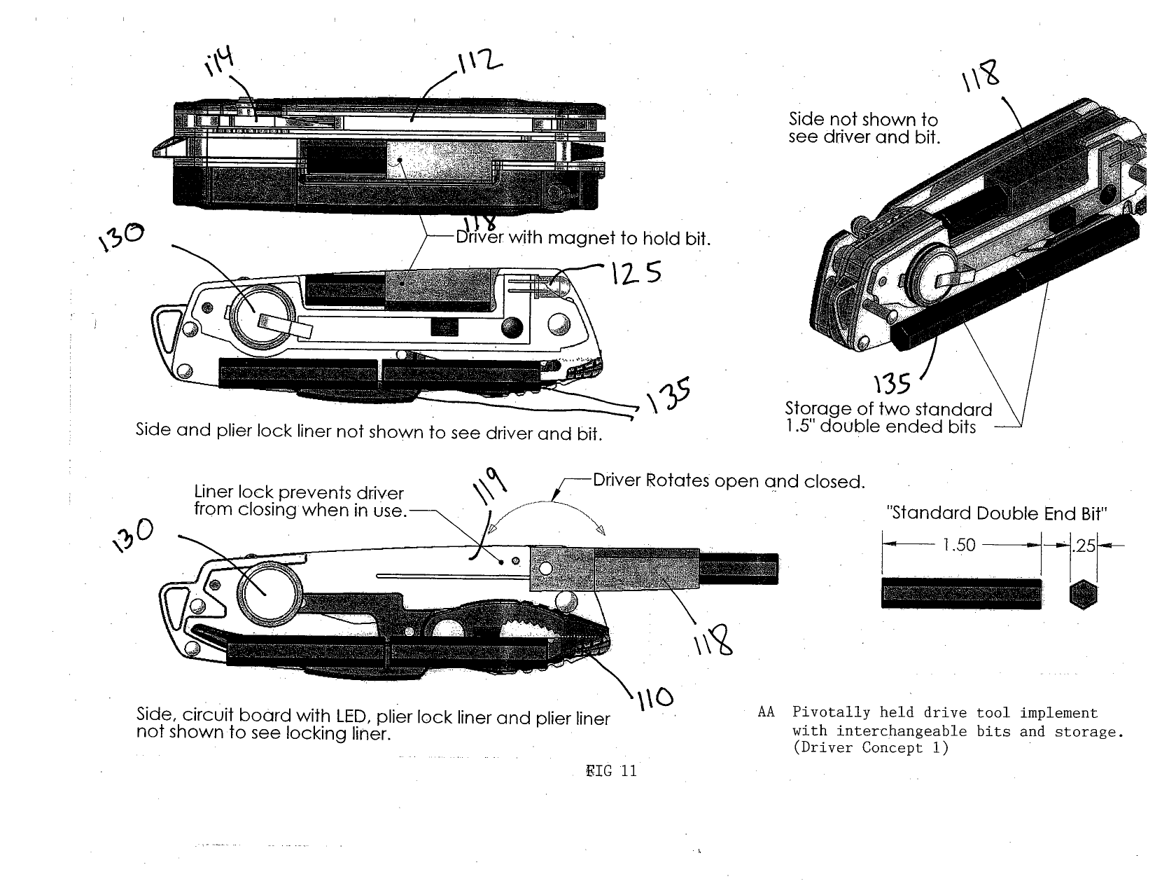

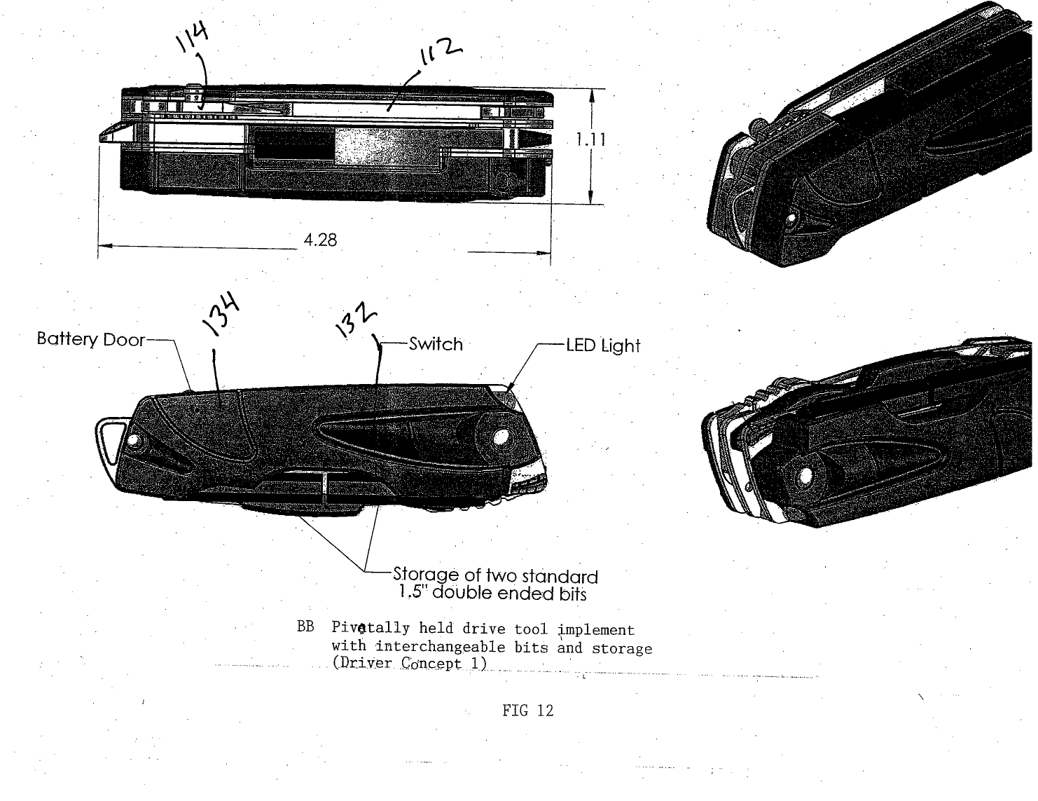

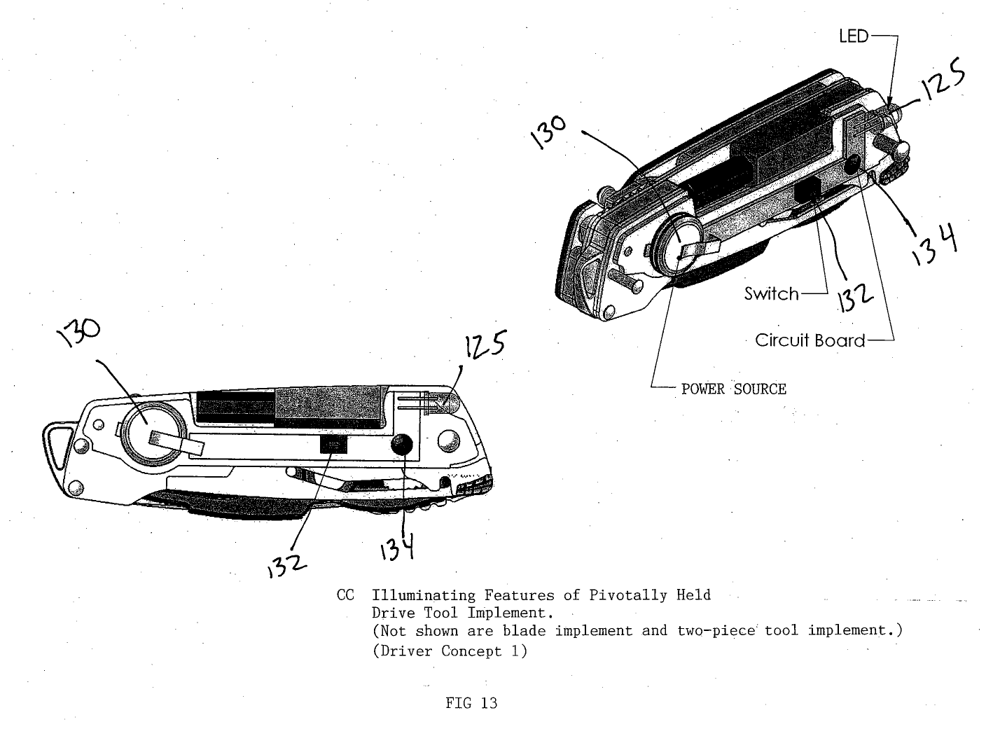

In the embodiment of a pivotally held drive tool implement with interchangeable bits and storage multi-tool shown in FIGS. 11-13, the folding knife tool has a pivoting driver 118 and an illuminating implement 125. A power source 130 powers the light source, a removable door 134 on the handle is present for replacing the power source 130, a power switch 132 is also shown on the handle. Also shown are the retractable pliers 110, a pivoting blade implement 112, a pivoting can or bottle opener implement 114, a liner lock 119 for locking the driver implement in the open position, and storage of two standard driver bits 135. FIG. 13 shows a cut away of the handle to reveal the illuminating features contemplated in an embodiment that has an illuminating device 125, a power source 130, a power switch 132 and a circuit board 134 for regulating the illumination levels or pulsing of the illuminating device 125.

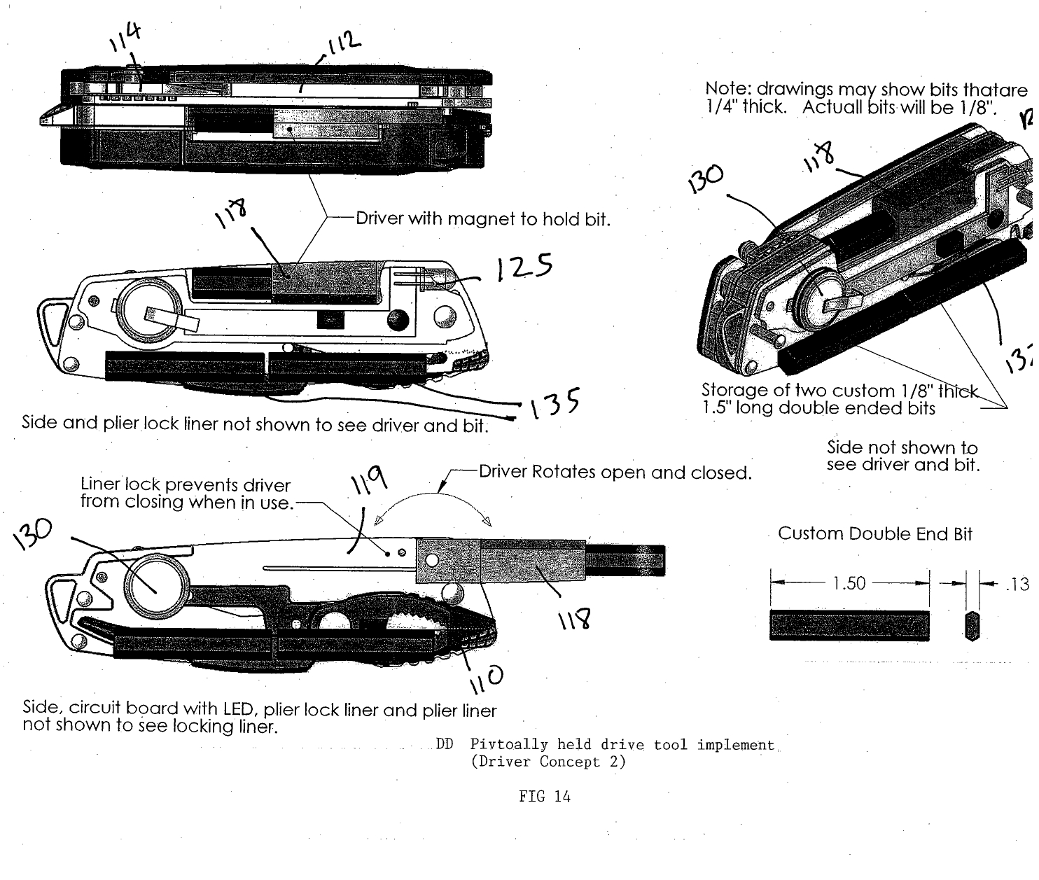

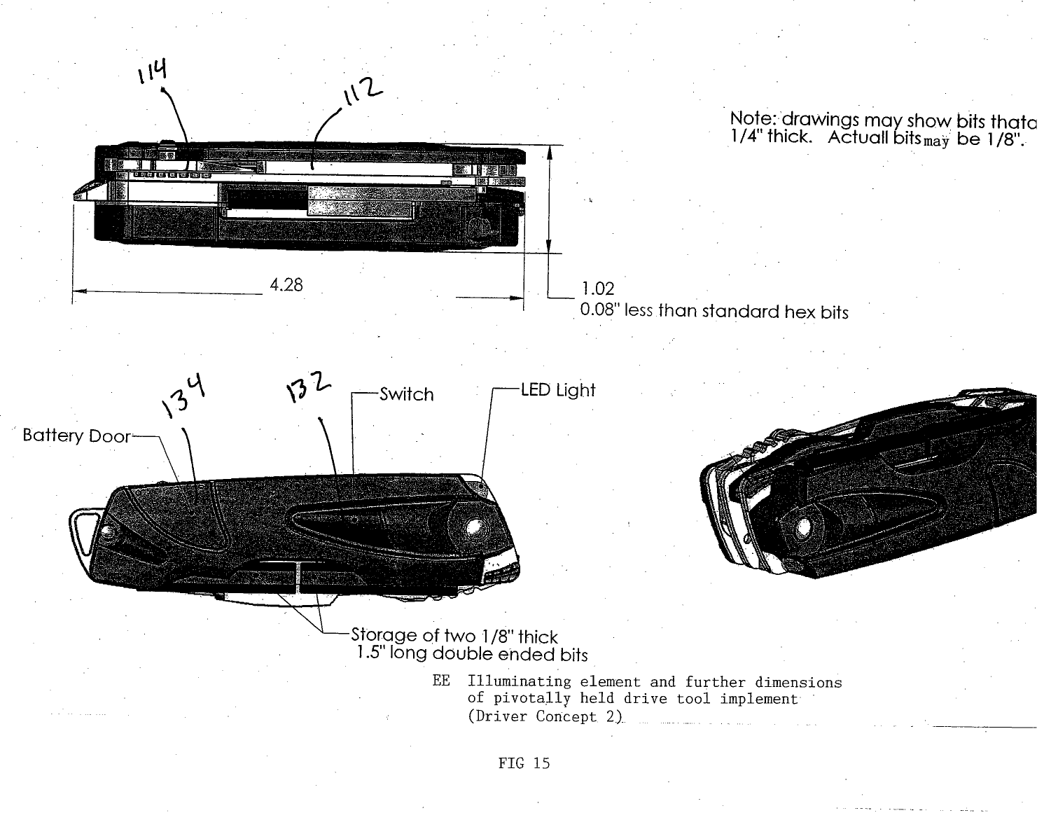

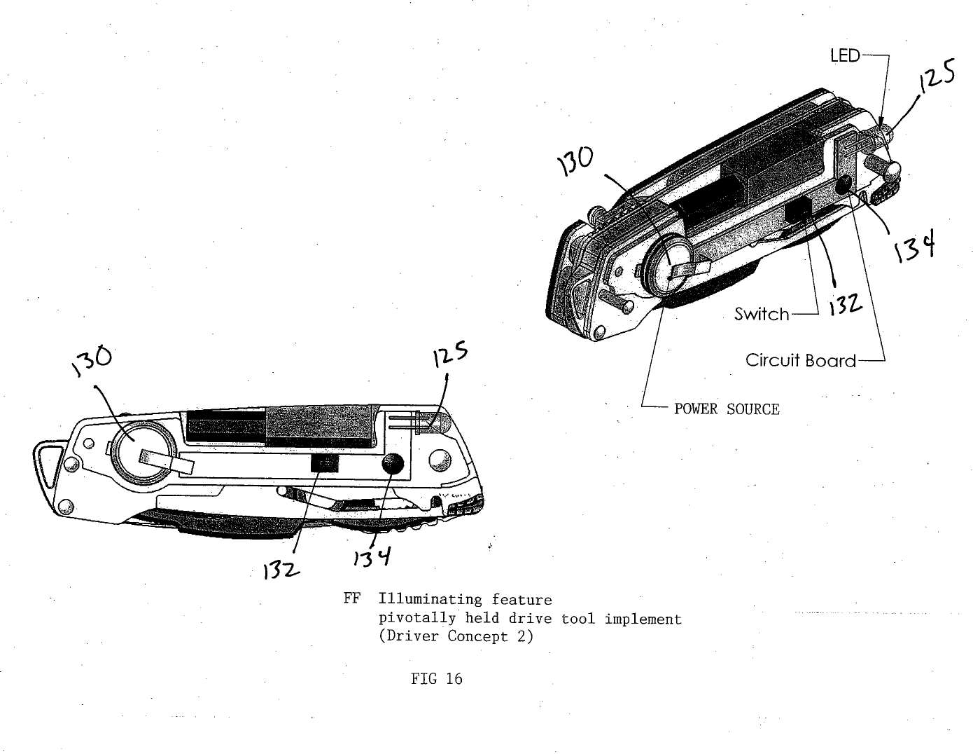

In another embodiment of a pivotally held drive tool implement with interchangeable bits and storage multi-tool shown in FIGS. 14-16, the folding knife tool has a pivoting driver 118 and an illuminating implement 125. A power source 130 powers the light source, a removable door 134 on the handle is present for replacing the power source 130, a power switch 132 is also shown on the handle. Also shown are the retractable pliers 110, a pivoting blade implement 112, a pivoting can or bottle opener implement 114, a liner lock 119 for locking the driver implement in the open position, and storage of two standard driver bits 135. FIG. 16 shows a cut away of the handle to reveal the illuminating features contemplated in an embodiment that has an illuminating device 125, a power source 130, a power switch 132 and a circuit board 134 for regulating the illumination levels or pulsing of the illuminating device 125.

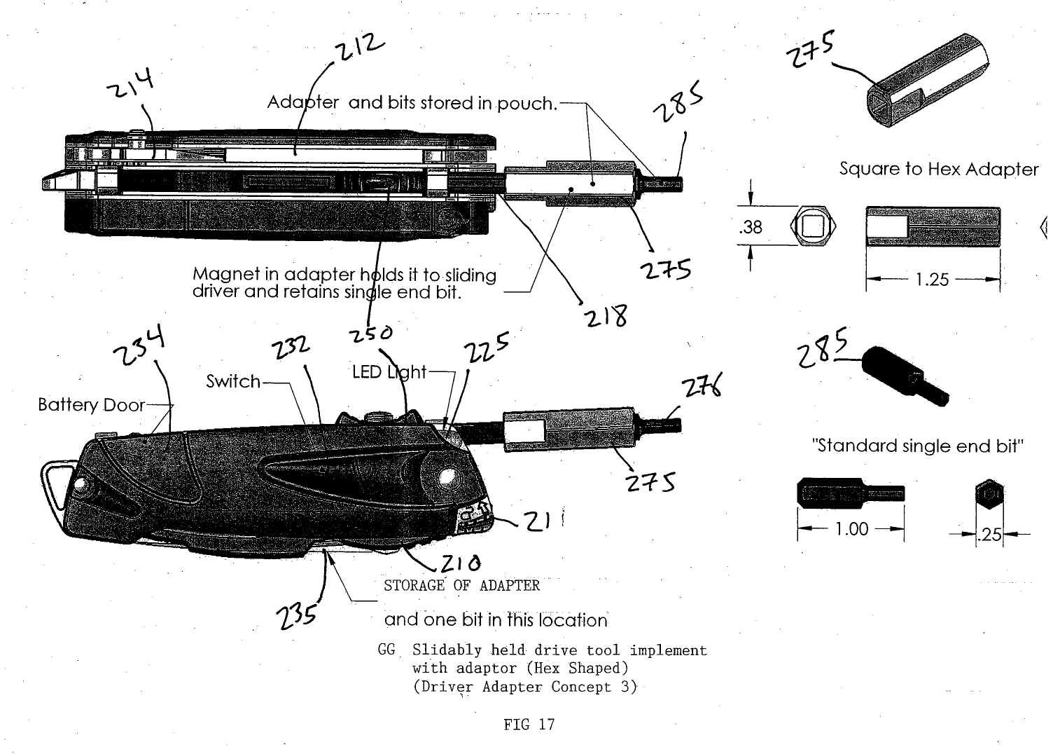

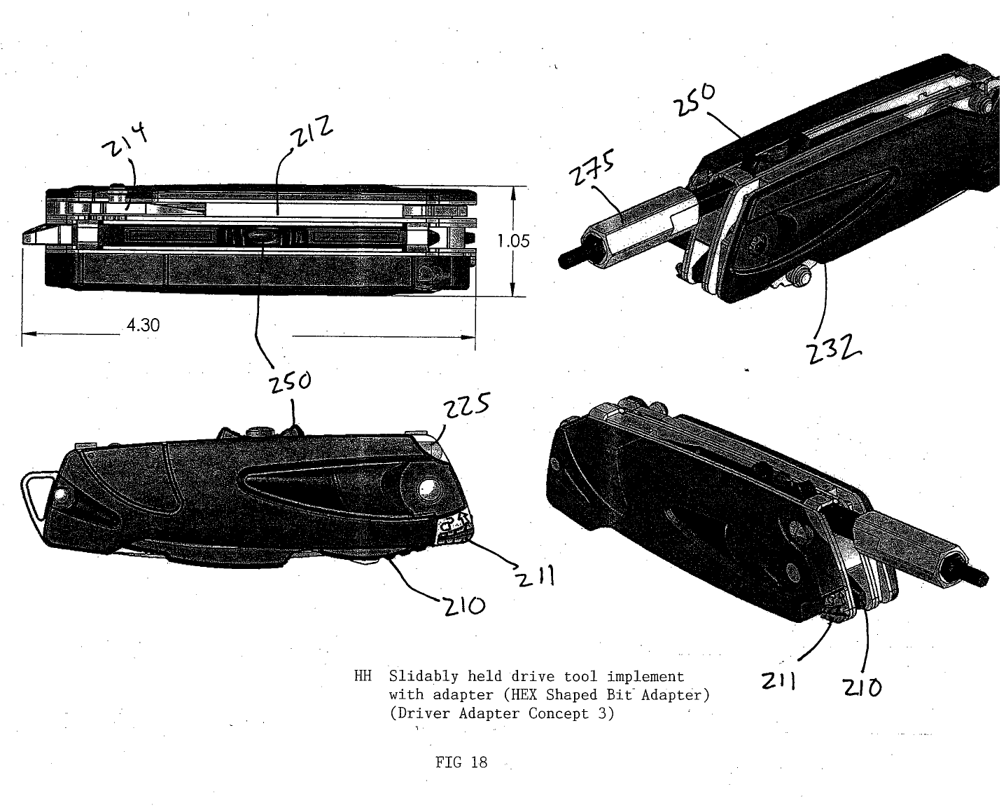

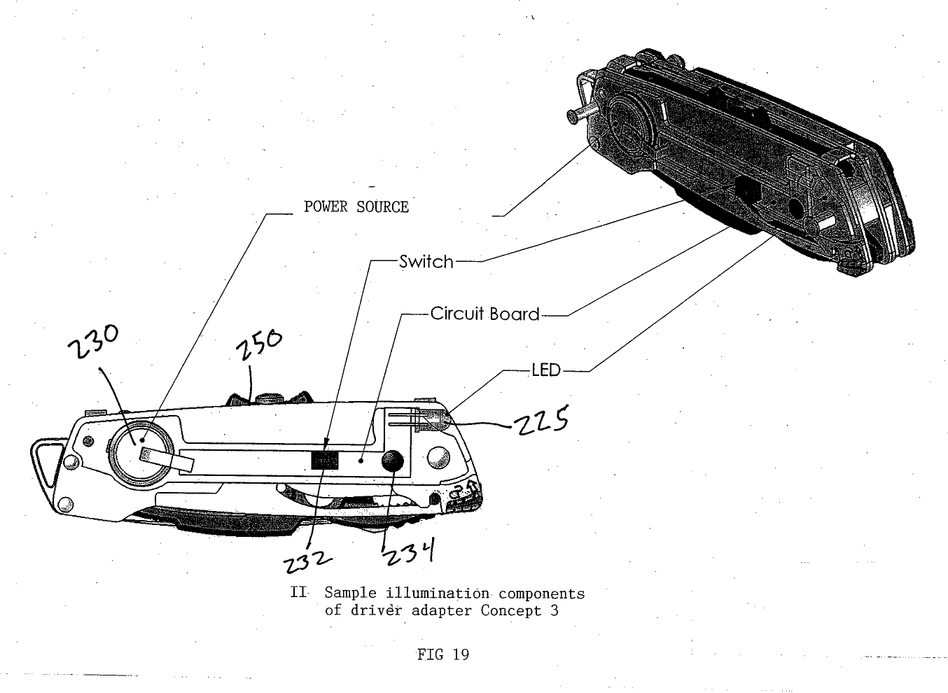

In an embodiment of a slidably held drive tool implement with interchangeable bits multi-tool shown in FIGS. 17-19, the folding knife tool has a slidably held driver 218 and an illuminating implement 225. A power source 230 powers the light source, a removable door 234 on the handle is present for replacing the power source 230, a power switch 232 is also shown on the handle. Also shown are the retractable pliers 210, and the lock for the retractable pliers 211 which locks the retractable pliers 210 into the protruded use position and the retracted stored position. Further shown are a pivoting blade implement 212, a pivoting can or bottle opener implement 214, a button pin lock 250 for locking the driver implement in both the use position and stored position. A storage area 235 for storing a square to hex adapter 275 and one hex bit 285 is also shown in FIG. 17. FIG. 19 shows a cut away of the handle to reveal the illuminating features contemplated in an embodiment that has an illuminating device 225, a power source 230, a power switch 232 and a circuit board 234 for regulating the illumination levels or pulsing of the illuminating device 225.

All references cited herein, including patents, patent applications, and publications, are hereby incorporated by reference in their entireties, whether previously specifically incorporated or not.

Having now fully described this invention, it will be appreciated by those skilled in the art that the same can be performed within a wide range of equivalent parameters, concentrations, and conditions without departing from the spirit and scope of the invention and without undue experimentation.

While this invention has been described in connection with specific embodiments thereof, it will be understood that it is capable of further modifications. This application is intended to cover any variations, uses, or adaptations of the invention following, in general, the principles of the invention and including such departures from the present disclosure as come within known or customary practice within the art to which the invention pertains and as may be applied to the essential features hereinbefore set forth.

What is claimed is:

1. A multi-function tool comprising:
a handle;
a folding blade implement; and a two-piece tool implement;
wherein said folding blade implement is pivotally connected to the handle of said multi-function tool, is folded within the handle when in a stored state, and is pivotally rotated out of the handle when in use;
wherein said two-piece tool implement is slidably held so that said two-piece tool implement is retracted within the handle when in the stored state, and slidably extended to protrude from said handle when in use.

2. The multi-function tool of claim 1 wherein said two-piece tool implement is a retractable pliers.

3. The multi-function tool of claim 1 further comprising a drive tool implement.

4. The multi-function tool of claim 3 wherein said drive tool implement is slidably held so that said drive tool implement is retracted within the handle when in the stored state, and slidably extended to protrude from said handle when in use.

5. The multi-function tool of claim 1 further comprising a illuminating element either fixed on said handle, or pivotally or flexibly, attached to said handle; wherein said illuminating element is used to illuminate an area in relation to the blade or tool implement in use.

6. The multi-function tool of claim 5 wherein said illuminating element is fixed within the handle.

7. The multi-function tool of claim 5 wherein said illuminating element is a Light Emitting Diode (LED).

8. The multi-function tool of claim 1 further comprising at least one drive tool implement; and a illuminating element;
wherein said drive tool implement is pivotally connected to the handle, is folded within the handle when in a stored state, and pivotally rotated out of the handle when in use; and
wherein said illuminating element is either fixed on said handle, or pivotally or flexibly, attached to said handle; and wherein said illuminating element is used to illuminate an area in relation to the blade or tool implement in use.

9. A multi-function tool comprising:
a handle;
a folding blade implement; a drive tool implement; and a two-piece tool implement;
wherein said folding blade implement is pivotally connected to the handle of said multi-function tool, is folded within the handle when in a stored state, and is pivotally rotated out of the handle when in use;
wherein said drive tool implement is slidably held so that said drive tool implement is retracted within the handle when in the stored state, and slidably extended to protrude from said handle when in use;
wherein said two-piece tool implement is slidably held so that said two-piece tool implement is retracted within the handle when in the stored state, and slidably extended to protrude from said handle when in use, and locked into an extended position while in use.

10. The multi-function tool of claim 9 wherein said two-piece tool implement is locked within the handle when in the stored state.

11. The multi-function tool of claim 9 wherein said folding blade implement is locked into an open position when in use.

12. The multi-function tool of claim 9 wherein said drive tool implement is capable of being locked into a retracted position within the handle when in the stored state.

13. The multi-function tool of claim 10 wherein said drive tool implement is locked into said use position and said stored position with a locking button pin.

14. A folding knife tool comprising:
a handle;
supporting liners within the handle;
locking liners within the handle which lock the blade or pliers in a fixed open position, and a tracking liner within the handle for retracting and extending pliers, and a double-ended driver;
a blade pivotally connected to the handle;
and a means for retracting and extending pliers;
wherein the pliers having a first exposed handle and a second unexposed handle slidably connected to the folding knife handle;
wherein the exposed pliers handle is extended or retracted within the folding knife handle;
the pliers having two button pins fixed to its second unexposed handle; and
the pins allow the pliers to slide within two tracks within the tracking liner, one for each pin keeping the pliers pointing in a fixed orientation.

15. The folding knife tool according to claim 14, wherein the pliers are locked into the open position by means of a pin fixed to the handle which slides within a track of the folding knife handle and is held in position by a locking arm formed by a locking liner; and the pliers are unlocked with force on a button connected to the locking liner arm releasing the pin and allowing sliding movement of the pliers.

16. The folding knife tool according to claim 14, further comprising within the folding knife handle a double ended driver slidably connected to the tracking liner by pins fixed to the driver that slide within a single track within the tracking liner; the driver being able to slide with force in either sideways direction; one direction to expose one driver type at one end and the other direction to expose another driver type at the other end.

17. The folding knife tool according to claim 16 wherein said double ended driver is locked into a protruded position in either sideways direction when in a use mode and locked into a center position within the handle of said tool when in a stored mode.

18. The folding knife tool of claim 17 wherein said double ended driver is locked into said protruded position and/or locked into said center position with a locking button pin.

19. The folding knife tool according to claim 16, wherein said double ended driver comprises a phillips head screwdriver on one end and a standard slot or flat head screwdriver on the opposing end.

20. The folding knife tool of claim 14 further comprising a illuminating element fixed within said handle, wherein said illuminating element is used to illuminate an area in relation to the blade or tool implement in use.
